(19) United States
(12) Patent Application Publication
(10) Pub. No.: US 2026/0212058 A1
(43) Pub. Date: Jul. 23, 2026

(54) GENERATIVE DESIGN WORKFLOW WITH PROMPT STORAGE AND RETRIEVAL

(71) Applicant: AUTODESK, INC., San Francisco, CA (US)

(72) Inventors: Jo Karel VERMEULEN, Toronto (CA); Justin Frank MATEJKA, Newmarket (CA); George William FITZMAURICE, Toronto (CA)

(21) Appl. No.: 19/454,910

(22) Filed: Jan. 21, 2026

Related U.S. Application Data
(60) Provisional application No. 63/748,340, filed on Jan. 22, 2025.

(51) Int. Cl. G06F 30/12; G06F 30/27

(52) U.S. Cl. CPC G06F 30/12; G06F 30/27

(57) ABSTRACT

Various embodiments include a computer-implemented method for generating designs, including determining a design context based on a first user input, retrieving a set of design prompts based on the design context, determining a first design prompt included in the set of design prompts based on a second user input, retrieving a set of design options based on the first design prompt, determining a first design option included in the set of design options based on third user input, and incorporating the first design option into the design context.

### CROSS-REFERENCE TO RELATED APPLICATIONS

The present application claims priority benefit of the United States Provisional Patent Application titled, "TECHNIQUES FOR PROCESSING GENERATIVE Al MODEL PROMPTS," having Serial Number 63/748,340 and filed on January 22, 2025. The subject matter of this related application is hereby incorporated herein by reference.

### BACKGROUND

### Field of the Various Embodiments

The present disclosure relates generally to computer science, artificial intelligence, and complex software and, more specifically, to a generative design workflow with prompt storage and retrieval.

### Description of the Related Art

In a conventional computer-aided design (CAD) workflow, a designer uses various tools included in a CAD program to generate or assemble geometry associated with a design. Typically, the tools provided by the CAD program allow the designer to manually specify various attributes of the design or to manipulate existing attributes of the design in an iterative and incremental manner. Some types of CAD programs now include machine learning models that implement generative artificial intelligence (AI) to automatically generate designs, or portions thereof, based on user prompts. A designer can describe high-level aspects of the design using natural language, and a machine learning model then automatically generates some or all of the design. Generative AI is becoming increasingly integrated into modern CAD workflows.

One drawback associated with the above approach is that machine learning models that implement generative Al often output very different designs when provided with similar input prompts. Such variability poses significant challenges in a team setting where consistency and adherence to company standards are needed. Another drawback of the above approach is that machine learning models that implement generative AI usually cannot recreate a particular design even when provided with the exact same input prompt. Consequently, designers sometimes must spend excessive amounts of time making small changes to input prompts in hopes of reproducing a previously generated design.

As the foregoing illustrates, what is needed in the art is a more effective technique for generating designs using generative AI.

### SUMMARY

Various embodiments include a computer-implemented method for generating designs, including determining a design context based on a first user input, retrieving a set of design prompts based on the design context, determining a first design prompt included in the set of design prompts based on a second user input, retrieving a set of design options based on the first design prompt, determining a first design option included in the set of design options based on third user input, and incorporating the first design option into the design context.

At least one technical advantage of the disclosed techniques relative to prior art is that the disclosed techniques enable reuse of design prompts and design options for similar design contexts, thereby promoting consistent design patterns across different users. Another technical advantage of the disclosed techniques is that the design options generated previously for such design prompts can be cached and reused, thereby obviating the need to regenerate design geometry when similar design contexts are encountered. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a system configured to implement one or more aspects of the invention;

FIG. 2 is a more detailed illustration of the design engine and the generative design database of FIG. 1, according to various embodiments;

FIG. 3 illustrates an exemplary design workspace that includes various design geometry, according to various embodiments;

FIG. 4 illustrates an exemplary design context that includes the design geometry of FIG. 3 and a corresponding design prompt, according to various embodiments;

FIG. 5 illustrates exemplary design options associated with the design prompt of FIG. 4, according to various embodiments;

FIG. 6 illustrates metadata associated with one of the design options of FIG. 5, according to various embodiments;

FIG. 7 illustrates one of the design options of FIG. 5 incorporated into the design workspace, according to various embodiments;

FIG. 8 illustrates the design context of FIG. 4 indicating multiple design prompt options, according to various embodiments;

FIG. 9 illustrates the multiple design prompt options of FIG. 8 in greater detail, according to various embodiments;

FIG. 10 illustrates how a prompt history can be accessed, according to various embodiments;

FIG. 11 illustrates an exemplary prompt history, according to various embodiments;

FIG. 12 illustrates exemplary design options retrieved in response to a user prompt, according to various embodiments; and

FIG. 13 is a flow diagram of method steps for incorporating design options into a design workspace based on a design context, according to various embodiments.

### DETAILED DESCRIPTION OF EXEMPLARY EMBODIMENTS

In the following description, numerous specific details are set forth to provide a more thorough understanding of the various embodiments. However, it will be apparent to one skilled in the art that the inventive concepts may be practiced without one or more of these specific details.

### System Overview

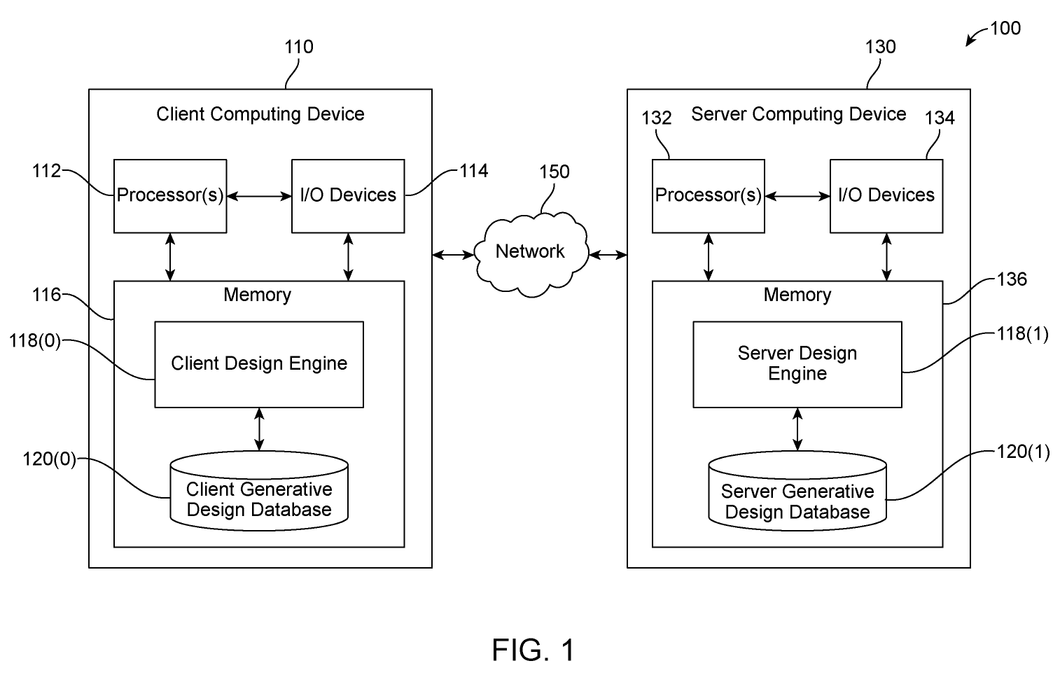

FIG. 1 is a block diagram of a system configured to implement one or more aspects of the invention. As shown, a generative design system 100 includes a client computing device 110 and a server computing device 130 coupled together via a network 150. The client computing device 110 or the server computing device 130 may be any technically feasible type of computer system, including a desktop computer, a laptop computer, a mobile device, a virtualized instance of a computing device, a distributed and/or cloud-based computer system, and so forth. The network 150 may be any technically feasible set of interconnected communication links, including a local area network (LAN), a wide area network (WAN), the World Wide Web, or the Internet, among others.

As further shown, the client computing device 110 includes at least one processor 112, input/output (I/O) devices 114, and a memory 116 coupled together. The processor 112 includes any technically feasible set of hardware units configured to process data and execute software applications. For example, and without limitation, the processor 112 could include one or more central processing units (CPUs) and/or one or more graphics processing units (GPUs). The I/O devices 114 include any technically feasible set of devices configured to perform input and/or output operations, including, for example and without limitation, a display device, a keyboard, and/or a touchscreen, among others.

The memory 116 includes any technically feasible storage media configured to store data and software applications, such as, for example and without limitation, a hard disk, a random-access memory (RAM) module, and/or a read-only memory (ROM). The memory 116 includes a client design engine 118(0) and a client generative design database 120(0). The client design engine 118(0) is a software application that, when executed by the processor 112, interoperates with a corresponding design engine executing on the server computing device 130 to coordinate a generative design workflow, as further described herein. The client generative design database 120(0) stores various data associated with the generative design workflow.

As also shown, the server computing device 130 includes a processor 132, I/O devices 134, and a memory 136 coupled together. The processor 132 includes any technically feasible set of hardware units configured to process data and execute software applications, such as one or more CPUs and/or one or more GPUs. The I/O devices 134 include any technically feasible set of devices configured to perform input and/or output operations, such as, for example and without limitation, a display device, a keyboard, and/or a touchscreen, among others.

The memory 136 includes any technically feasible storage media configured to store data and software applications, such as, for example and without limitation, a hard disk, a RAM module, and/or a ROM. The memory 136 includes a server design engine 118(1) and a server generative design database 120(1). The server design engine 118(1) is a software application that, when executed by the processor 132, interoperates with the client design engine 118(0) executing on the client computing device 110 to coordinate the generative design workflow mentioned above. The server generative design database 120(1) stores various data associated with the generative design workflow.

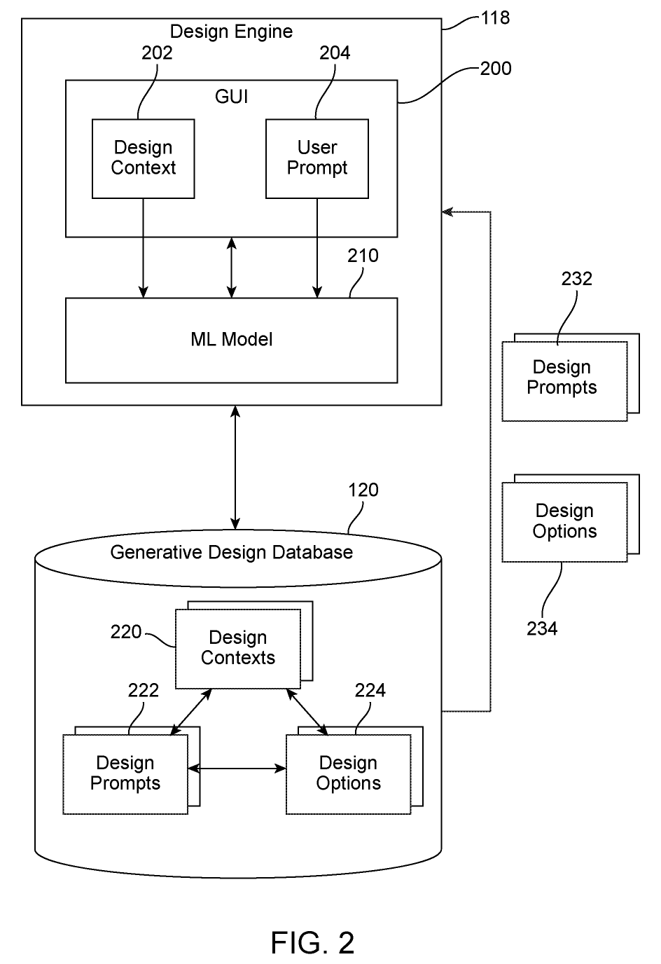

The client design engine 118(0) and the server design engine 118(1) represent separate portions of a distributed software entity configured to perform the various operations described herein and may be referred to collectively hereinafter as the design engine 118, as shown in FIG. 2. Similarly, the client generative design database 120(0) and the server generative design database 120(1) represent separate portions of a distributed storage entity configured to perform storage and retrieval operations associated with the various data discussed herein and may be referred to collectively hereinafter as the generative design database 120, as also shown in FIG. 2.

In operation, the design engine 118 interacts with a user to generate geometry within a design workspace during the generative design workflow mentioned previously. The design engine 118 receives user input indicating a design context that includes a subset of the geometry included in the design workspace. The design engine 118 queries the generative design database 120 to retrieve one or more design prompts that are associated with, or relevant to, the design context. Upon user selection of a given design prompt, the design engine 118 then retrieves from the generative design database 120 one or more design options corresponding to the selected design prompt and displays the one or more design options to the user. Upon selection of a given design option, the design engine 118 incorporates the selected design option into the design workspace. In this manner, the design engine 118 allows the user to review design prompts that may be relevant to the current design context and to then incorporate pre-existing design options without needing to regenerate such design options. The design engine 118 further facilitates the sharing of design prompts across different teams and projects, thereby increasing the efficiency with which designs can be generated.

### Generative Design Workflow with Prompt Storage and Retrieval

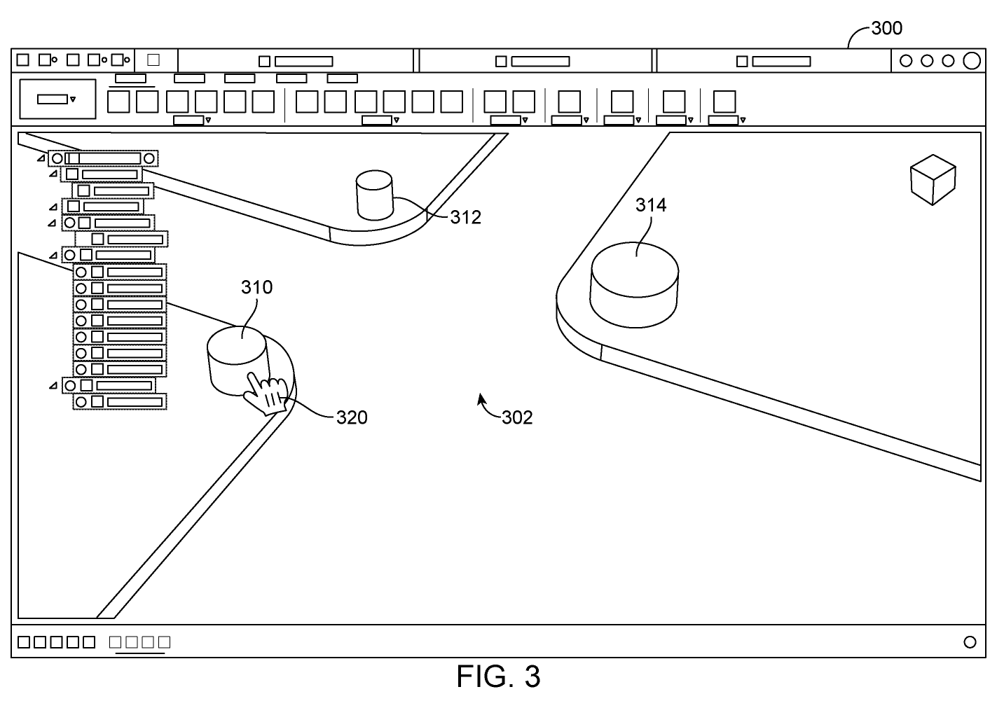

FIG. 2 is a more detailed illustration of the design engine and the generative design database of FIG. 1, according to various embodiments. As shown, the design engine 118 includes a graphical user interface (GUI) 200 and a machine learning (ML) model 210. The GUI 200 is a computer-aided design (CAD) application and includes various GUI elements that allow a user to generate and/or modify two-dimensional (2D) and/or three-dimensional (3D) geometry. The ML model 210 is a generative design application that is trained based on pre-existing design geometry and pre-existing user prompts to retrieve and/or generate design geometry in response to user prompts. The GUI 200 and the ML model 210 interoperate to support a generative design workflow. In particular, the GUI 200 interacts with the user to populate a design workspace with various design geometry, and the ML model 210 can then analyze and interpret the design workspace to modify and/or add to the design geometry, as further described by way of example below in conjunction with FIGS. 3-12.

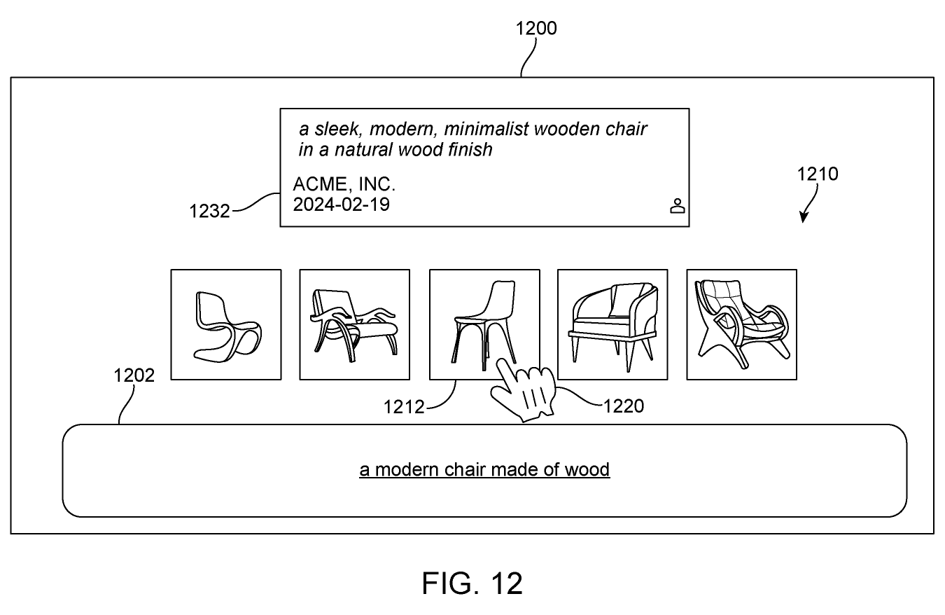

The GUI 200 includes a design context 202 and a user prompt 204. The design context 202 includes a selection of the various design geometry included in the design workspace. For example, and without limitation, the design context 202 could include a selection of parts included in an assembly that resides in the design workspace, or a bounding box that encapsulates a two-dimensional (2D) or three- dimensional (3D) portion of the design workspace. The user prompt 204 can be optionally provided by the user to add descriptive detail to the design context 202 or provided in lieu of the design context 202, as also described below in conjunction with FIG. 12.

The ML model 210 is trained to interpret the design context 202 and/or the user prompt 204 to facilitate the retrieval of various data from the generative design database 120 and/or the storing of various data in the generative design database 120. In various embodiments, the ML model 210 can generate a geometric embedding based on the design context 202 to facilitate searching a geometric embedding space and/or generate a semantic embedding based on the user prompt 204 to facilitate searching a semantic embedding space, as explained below in more detail. The ML model 210 can further be trained to generate various design geometry based on the user prompt 204 and/or generate various user prompts based on provided design geometry, where geometry and/or prompts generated in this manner can be stored to and retrieved from the generative design database 120.

The generative design database 120 includes design contexts 220, design prompts 222, and design options 224. The design contexts 220 include various sets of geometry derived from previous design workspaces and/or geometric embeddings of such geometry. The design prompts 222 include various text-based descriptions of design geometry derived from previous design workspaces and/or semantic embeddings of such descriptions. The design options 224 include geometry generated previously via the design prompts 222 and/or geometric embeddings of such geometry. The design contexts 220, the design prompts 222, and the design options 224 can reside within the generative design database 120 relative to one another according to any technically feasible type of relationship, including a one-to-one relationship, a one- to-many relationship, a many-to-one relationship, or a many-to-many relationship.

In various embodiments, for any given design context 220, the generative design database 120 includes a set of design prompts 222, and for any given design prompt 222, the generative design database 120 includes a set of design options 224, where a "set" can include zero or more elements. In some embodiments, one or more design options 224 can reside within the generative design database 120 with no corresponding design prompts 222 or, similarly, one or more design prompts 222 can reside within the generative design database 120 with no corresponding design context 220. When data is missing in such situations, the ML model 210 can generate the missing data using generative design techniques. For example, and without limitation, the ML model 210 could generate a design prompt 222 based on a design option 224, thereby generating a text-based description of the design option 224.

In operation, the user interacts with the GUI 200 to define the design workspace and then selects the design context 202 from within the design workspace. The ML model 210 queries the generative design database 120 based on the design context 202 to identify at least one design context 220 that is substantially similar to the design context 202. In one embodiment, the ML model 210 may generate a geometric embedding of the design context 202 and project the geometric embedding into a geometric embedding space that includes geometric embeddings of the design contexts 220 to identify a similar design context 220. The ML model 210 then retrieves one or more design prompts 232 associated with the identified design context 220. The design prompts 232 represent user-generated prompts that were used previously to generate design geometry within design workspaces having design contexts that are substantially similar to the design context 202.

The generative design database 120 returns the design prompts 232 to the design engine 118, and the GUI 200 can then display the design prompts 232 to the user. Upon selection of a given design prompt 232, the GUI 200 indicates the selected design prompt 232 to the generative design database 120, and the generative design database 120 then returns one or more design options 234 associated with the selected design prompt 232. The design options 234 associated with the selected design prompt 232 represent design geometry generated previously based on the selected design prompt 232. The GUI 200 displays the design options 234 to the user, and upon selection of any given design option 234, the GUI 200 incorporates the given design option 234 into the design context 202.

In various embodiments, the design engine 118 and the generative design database 120 interoperate to perform the above process repeatedly to incrementally add and/or modify design geometry within the design workspace over several interactions. The design engine 118 further allows the user to modify design prompts 232 and potentially re-generate corresponding design options 234 as needed and then save the modified design prompts 232 and corresponding modified design options 234 to the generative design database 120. Design prompts and/or design options modified and/or generated in such a manner can then be shared across teams, projects, and/or organizations. In various embodiments, the generative design database 120 may include different libraries of design contexts 220, design prompts 222, and design options 224 associated with different individuals and/or groups, with relevant sharing permissions allowing granular access.

In various embodiments, the design engine 118 may allow the user to retrieve design options 224 without needing to first select a design context 202. For example, and without limitation, the GUI 200 could receive the user prompt 204 describing desired design geometry, and the ML model 210 could then generate a semantic embedding of the user prompt 204. The ML model 210 could then search a semantic embedding space that includes semantic embeddings of the design prompts 222 to identify relevant design options 224. Further, as mentioned above, in situations where design options 224 reside within the generative design database 120 with no corresponding design prompts 222, the ML model 210 can backfill the missing design prompts 222 by generating text descriptions of the design options 224.

Via the techniques described above, the design engine 118 and the generative design database 120 support a flexible and efficient generative design workflow that enhances the consistency of design geometry by re-using design prompts and design options across similar design contexts. The disclosed approach can therefore increase adherence to team, project, organization, and/or company standards, while also increasing the efficiency with which designs can be generated. In particular, re-using design options 224 in the manner described obviates the need to re-generate design geometry. The various techniques described thus far are described in greater detail by way of example below in conjunction with FIGS. 3-12.

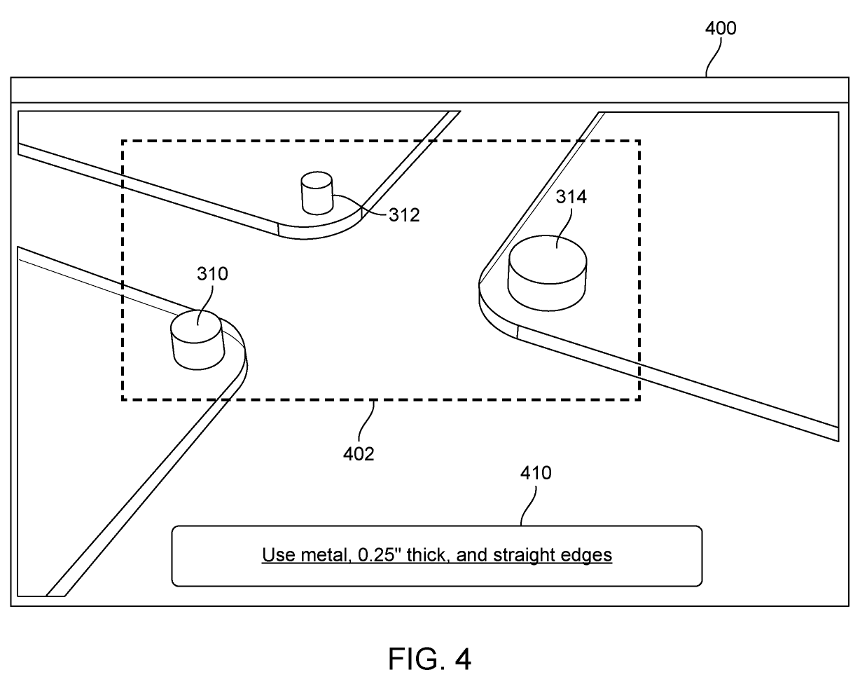

FIG. 3 illustrates an exemplary design workspace that includes various design geometry, according to various embodiments. As shown, a view 300 includes a design workspace 302. The GUI 200 generates the view 300 when interacting with the user. The design workspace 302 represents a 3D volume of space where the user can generate and/or modify geometry via interactions with the GUI 200, and/or where the ML model 210 can generate and/or modify geometry based on user input. The design workspace 302 includes design geometry 310, 312, and 314, each of which appears as a cylindrical post coupled to a plate. Using the cursor 320, the user can select the design geometry 310, 312, and 314 for inclusion into a design context, as shown in FIG. 4.

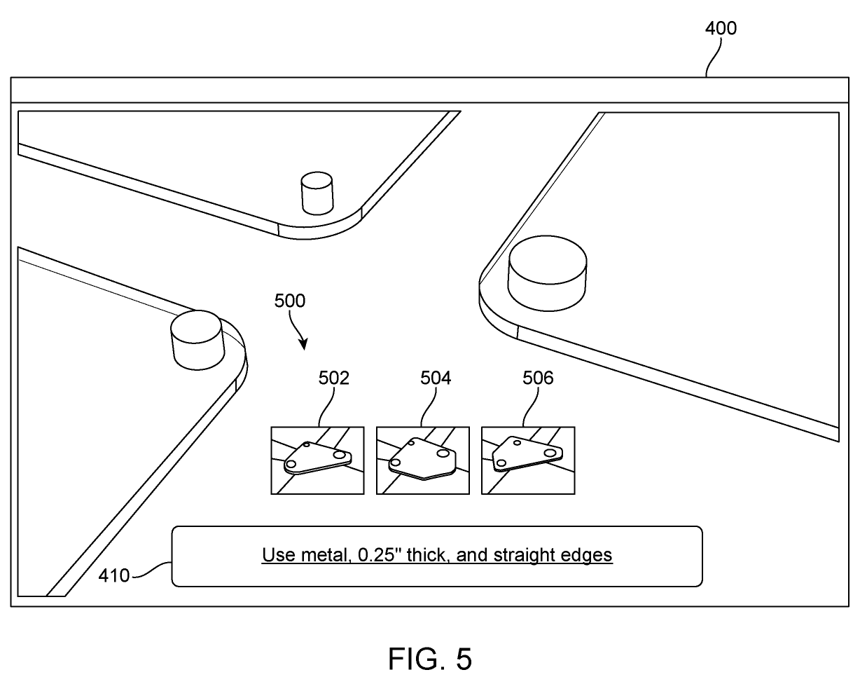

FIG. 4 illustrates an exemplary design context that includes the design geometry of FIG. 3 and a corresponding design prompt, according to various embodiments. As shown, a view 400 includes the design geometry 310, 312, and 314 included in a design context 402. In one embodiment, the design context 402 is defined as a bounding box that encapsulates a 2D or 3D region of the design workspace 302 that includes the design geometry 310, 312, and 314 (and potentially other design geometry). In operation, the ML model 210 queries the generative design database 120 based on the design context 402 and retrieves a design prompt 410 corresponding to the design context 402. In so doing, the ML model 210 can generate a geometric embedding of the design context 402, identify similar design contexts stored in the generative design database 120 based on the embedding, and then retrieve a design prompt associated with the similar design contexts. The design prompt 410 can appear as a suggestion via greyed font, which allows the user to modify the design prompt 410 or to confirm that the design prompt 412 is acceptable, as shown in FIG. 5.

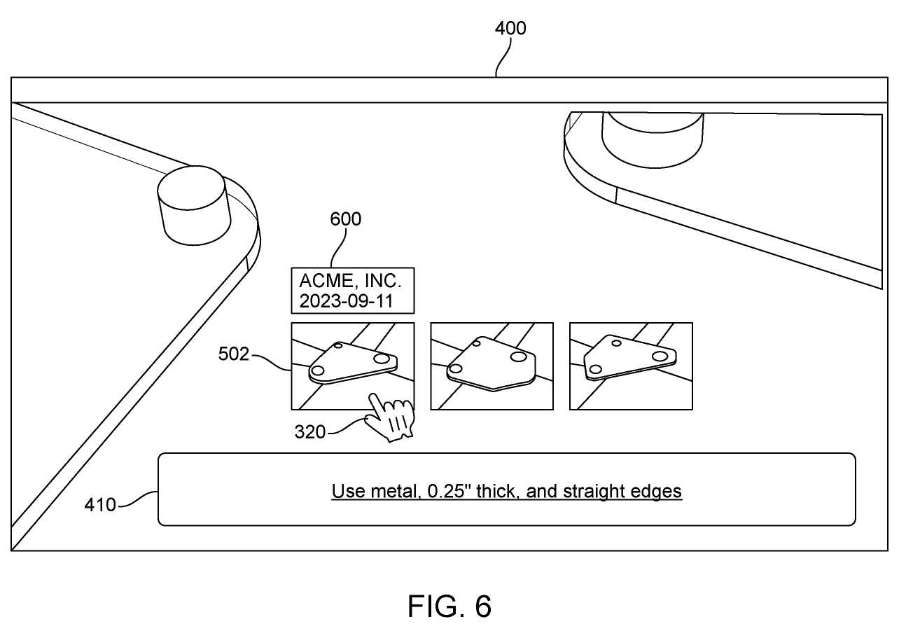

FIG. 5 illustrates exemplary design options associated with the design prompt of FIG. 4, according to various embodiments. Once the design prompt 402 is confirmed via user input, the design prompt 410 may appear via a darker font, which indicates such confirmation. Based on the design prompt 410, the generative design database 120 returns design options 500 corresponding to the design prompt 410, including design options 502, 504, and 506. In situations where the user modifies the design prompt 410 prior to confirmation, in some embodiments, the ML model 210 can retrieve relevant design options 224 based on a semantic search of the design prompts 222. The GUI 200 can display various metadata related to each design option 500 in response to user input, as shown in FIG. 6.

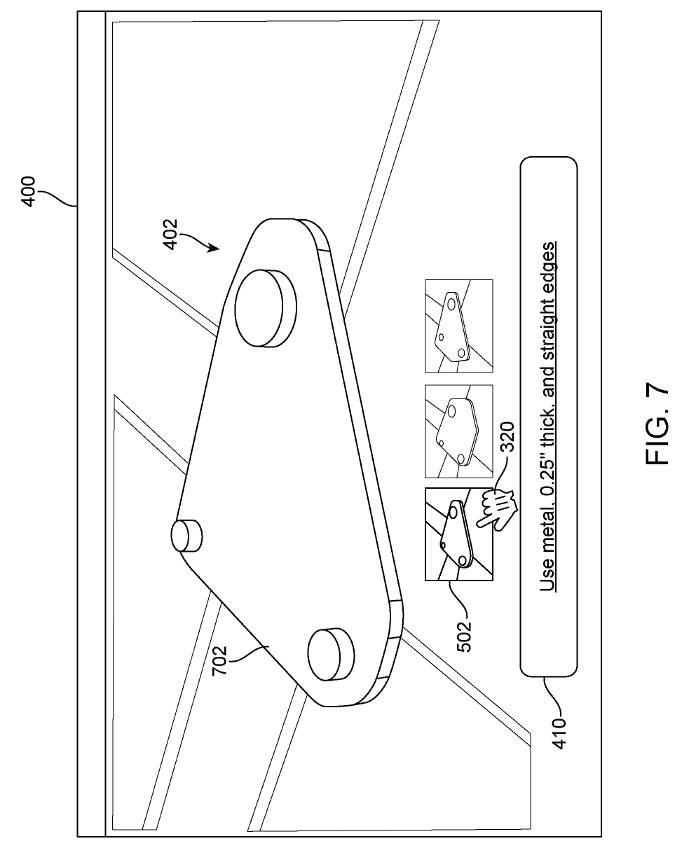

FIG. 6 illustrates metadata associated with one of the design options of FIG. 5, according to various embodiments. As shown, the GUI 200 displays metadata 600 for the design option 502 when the user hovers the cursor 320 over the design option 502. The GUI 200 can display any technically feasible metadata associated with any given design option. Once the user selects a given design option 500, the selected design option 500 can be incorporated into the design workspace 302, as shown in FIG. 7.

FIG. 7 illustrates one of the design options of FIG. 6 incorporated into the design workspace, according to various embodiments. As shown, the design workspace 302 includes additional design geometry 702 corresponding to the design option 502. Upon selection of the design option 502 via the cursor 320, the generative design database 120 returns the design geometry 702 associated with the design option 502, and the GUI 200 updates the design workspace 302 to include the design geometry 702 within the design context 402 in the manner shown.

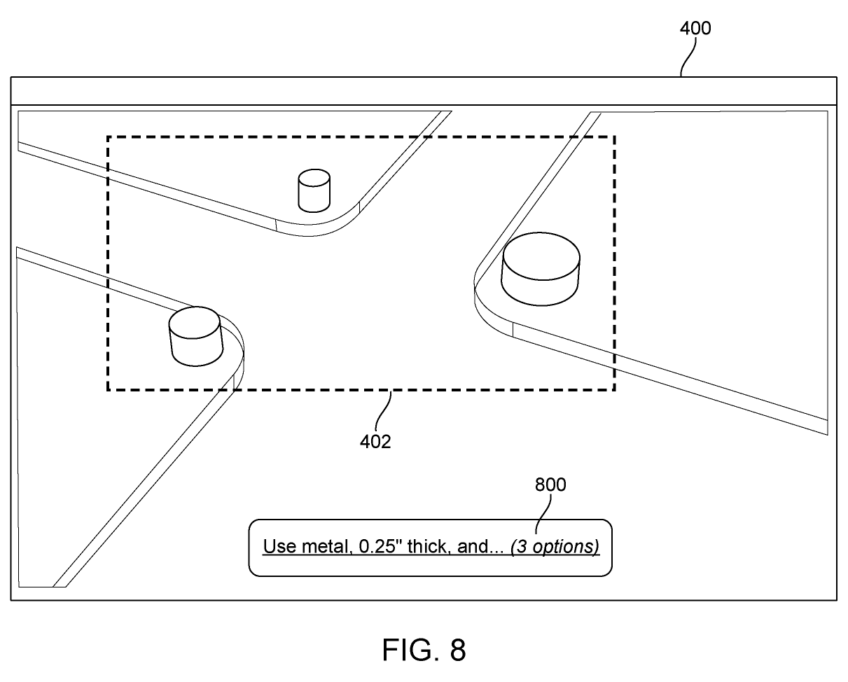

Referring generally to FIGS. 3-7, the design engine 118 and the generative design database 120 interoperate to facilitate a generative design workflow whereby users need not reproduce design prompts and/or design options when faced with similar design contexts. The disclosed techniques therefore promote consistent design patterns across different users, teams, projects, and organizations. The disclosed techniques furthermore increase design efficiency by reducing the need to regenerate similar design geometry for similar design contexts. Various extensions to the disclosed techniques are described below in conjunction with FIGS. 8-12.

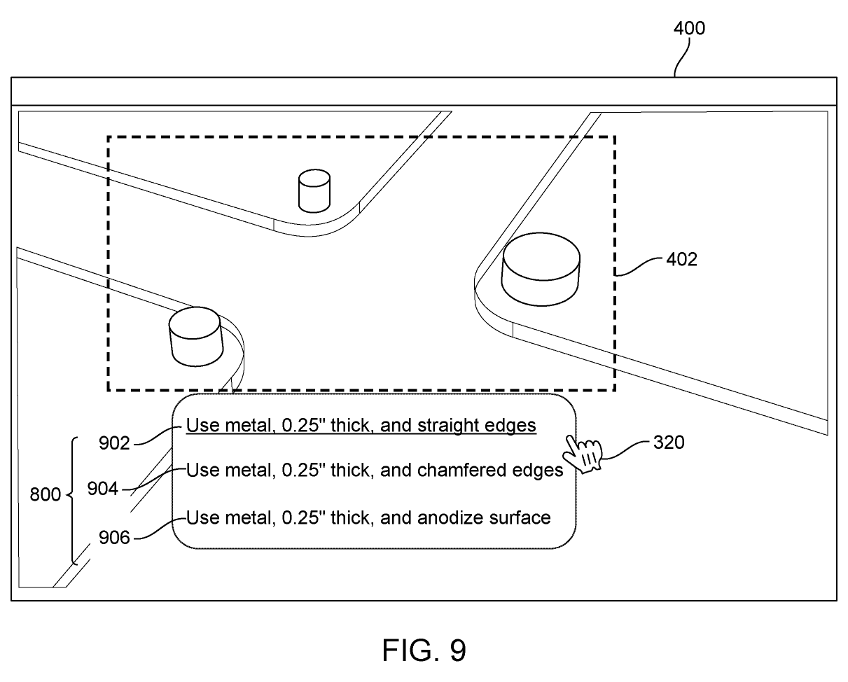

FIG. 8 illustrates the design context of FIG. 4 indicating multiple design prompt options, according to various embodiments. In one embodiment, the generative design database 120 can return multiple design prompts based on a given design context 402. As shown, the view 400 indicates via option display 800 that the design context 402 corresponds to three different design prompt options, as also shown in FIG. 9.

FIG. 9 illustrates the multiple design prompt options of FIG. 8 in greater detail, according to various embodiments. As shown, the option display 800 is expanded to show design prompt options 902, 904, and 906. In one embodiment, each of the design prompt options 902, 904, and 906 correspond to one design context 220 that is stored in the generative design database 118 and determined to be substantially similar to the design context 402. In another embodiment, the various design prompt options 902, 904, and 906 can be associated with different design contexts 220 stored in the generative design database 120 that are also determined to be substantially similar to the design context 402.

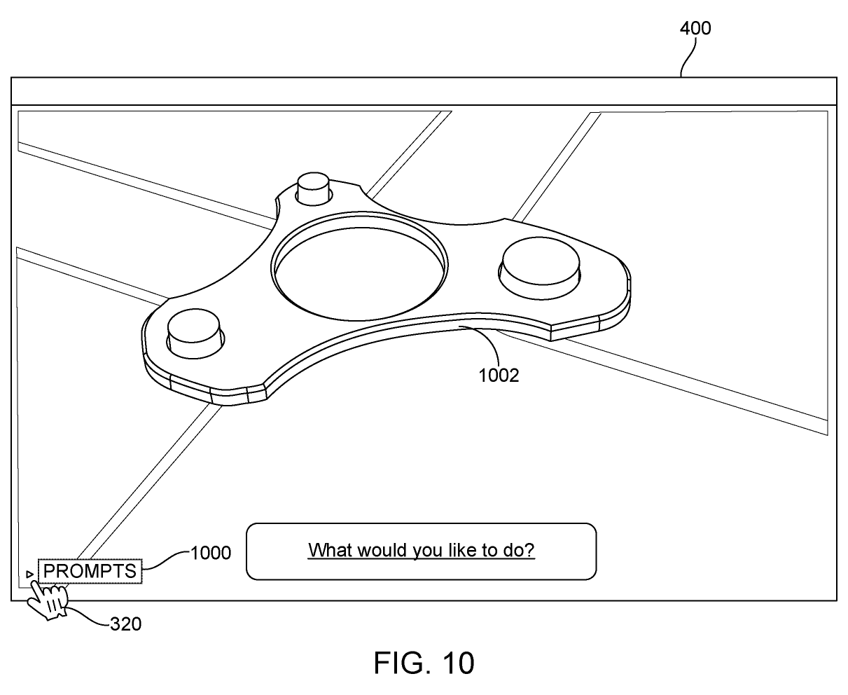

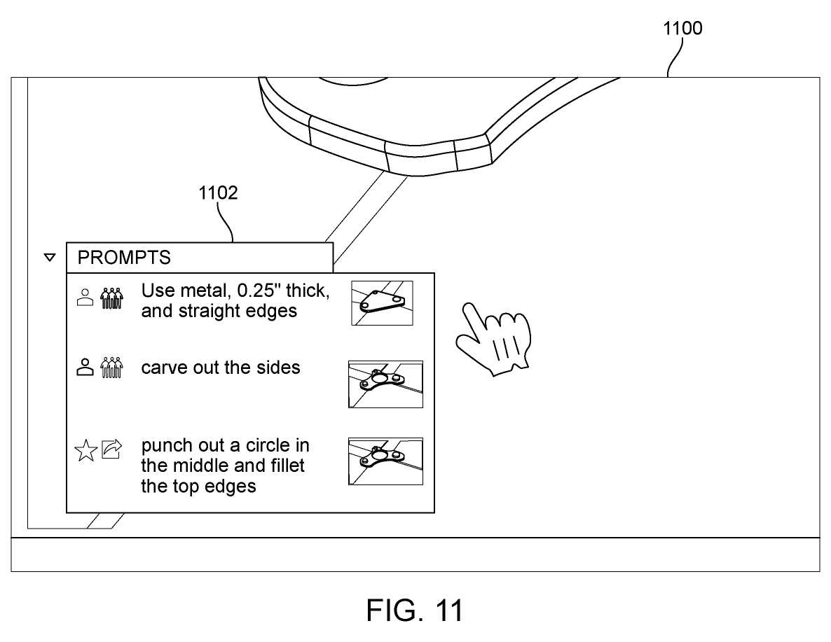

FIG. 10 illustrates how a prompt history can be accessed, according to various embodiments. As shown, the view 400 includes a prompts button 1000 and design geometry 1002. When accessed via the cursor 320, the GUI 200 can display a history of prompts used to generate the design geometry 1002, as shown in FIG. 11.

FIG. 11 illustrates an exemplary prompt history, according to various embodiments. As shown, a view 1100 displays a prompt history 1102 that is revealed upon selection of the prompt button 1000 via the cursor 320. The prompt history 1102 indicates sequential prompts that were selected, generated, and/or modified based on user input to generate the design geometry 1002. The prompt history 1102 further includes various icons indicating whether a given design prompt 222 is derived from a community library of design prompts stored in the generative design database 120 (multi-person icon) or derived from a personal library of design prompts specific to the user (single-person icon). The prompt history 1102 can further include icons allowing the user to save a design prompt 222 to the personal library (star icon) or share a design prompt 222 to a community library (share icon). When saving a design prompt 222, in various embodiments, the GUI 200 can present GUI elements that allow the user to select whether to save only the design prompt 222, or the design prompt 222 and corresponding design option 224, and/or which parts of the design context 220 should be saved.

FIG. 12 illustrates exemplary design options retrieved in response to a user prompt, according to various embodiments. In some situations, the generative design database 120 can return various results without needing a design context 220 to be provided as input. In particular, as shown, a view 1200 includes a user prompt 1202 and various design options 1210 returned by the generative design database 120 based on the user prompt 1202. In operation, the ML model 210 can generate a semantic embedding of the user prompt 1202 and then search a semantic embedding space to identify design prompts 222 that are substantially similar (i.e., within a threshold distance in the semantic design space) and then retrieve the design options 1210 corresponding to the substantially similar design prompts 222. When a cursor 1220 is placed within the view 1200 over a given design option 1212, the GUI 200 can display metadata 1232 related to the design option 1212.

In one embodiment, various design options 224 can reside within the generative design database 120 without any corresponding design prompts 222 or design contexts 220. For example, and without limitation, a given design option 224 generated manually before the advent of generative design technology could be included in the generative design database 120 without a corresponding design prompt 222. In such situations, the ML model 210 can analyze the design option 224 and generate a design prompt 222 using techniques that allow text descriptions to be generated based on imagery.

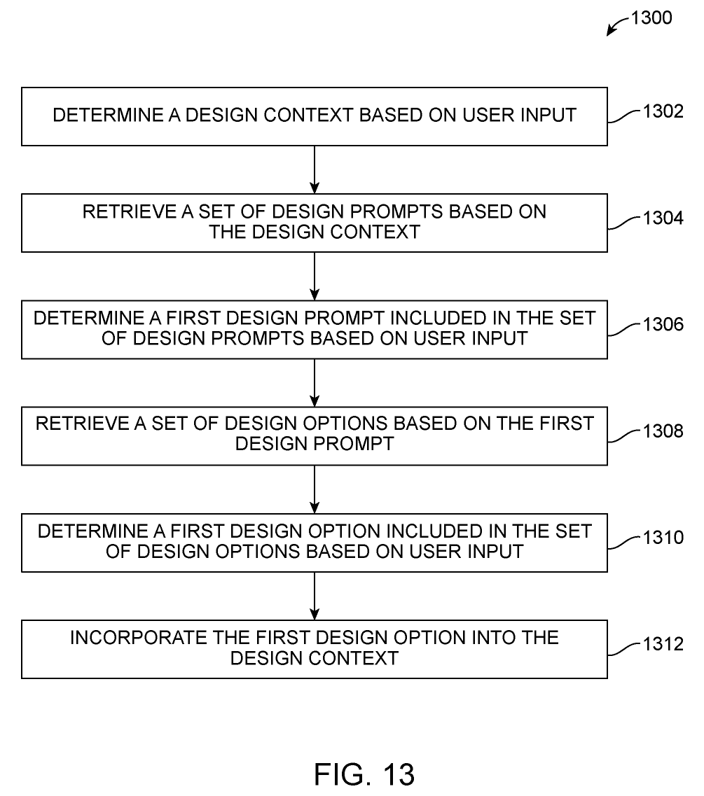

FIG. 13 is a flow diagram of method steps for incorporating design options into a design workspace based on a design context, according to various embodiments. Although the method steps are described in conjunction with the systems of FIGS. 1- 13, persons skilled in the art will understand that any system configured to perform the method steps, in any order, is within the scope of the present embodiments.

As shown, a method 1300 begins at step 1302, wherein the design engine 118 determines a design context based on user input. The design context 202 includes a selection of the various design geometry included in the design workspace. For example, and without limitation, the design context 202 could include a selection of parts included in an assembly that resides in the design workspace or a bounding box that encapsulates a two-dimensional (2D) or three-dimensional (3D) portion of the design workspace.

At step 1304, the design engine 118 retrieves a set of design prompts (e.g., the design prompts 232) based on the design context. In particular, the ML model 210 within the design engine 118 queries the generative design database 120 based on the design context 202 to identify at least one design context 220 that is substantially similar to the design context 202. In one embodiment, the ML model 210 may generate a geometric embedding of the design context 202 and project the geometric embedding into a geometric embedding space that includes geometric embeddings of the design contexts 220 to identify a similar design context 220. The ML model 210 then retrieves the set of design prompts associated with the identified design context 220. The set of design prompts represent user-generated prompts that were used previously to generate design geometry within design workspaces having design contexts that are substantially similar to the design context 202.

At step 1306, the design engine 118 determines a first design prompt included in the set of design prompts based on user input. The user can select the first design prompt from the various design prompt options and, in some embodiments, edit any given design prompt prior to selecting the first design prompt.

At step 1308, the design engine 118 retrieves a set of design options (e.g., the design options 234) based on the first design prompt. Upon selection of the first design prompt, the GUI 200 within the design engine 118 indicates the first design prompt to the generative design database 120, and the generative design database 120 then returns the set of design options associated with the first design prompt. The set of design options associated with the first design prompt represent design geometry generated previously based on the first design prompt.

At step 1310, the design engine 118 determines a first design option included in the set of design options based on user input. The GUI 200 can display the set of design options to the user and, upon various user interactions, display metadata associated with any given design option. The design engine 118 determines the first design option in response to a user selection of the first design option.

At step 1312, the design engine 118 incorporates the first design option into the design context. In particular, the design engine 118 retrieves design geometry associated with the first design option and then integrates the design geometry into the design workspace relative to the design context. In this manner, the design engine 118 allows users to reuse design geometry that was previously generated for similar design contexts, thereby promoting consistent design patterns and adherence to various team, project, and organization standards.

In sum, a design engine is configured to interoperate with a generative design database to support a generative design workflow. The design engine generates a design workspace that includes various design geometry based on interactions with a user. The design engine then identifies, based on further interactions with the user, a design context within the design workspace, where the design context includes a subset of the design geometry. The design engine queries the generative design database using the design context to identify a similar design context within a library of design contexts stored previously. The generative design database identifies one or more design prompts associated with the similar design context. Upon user selection of one design prompt from the one or more design prompts, the generative design database returns one or more design options corresponding to the selected design prompt. The one or more design options represent design geometry generated previously based on the selected design prompt. Upon selection of one design option from the one or more design options, the design engine incorporates the selected design option into the design workspace.

At least one technical advantage of the disclosed techniques relative to prior art is that the disclosed techniques enable reuse of design prompts and design options for similar design contexts, thereby promoting consistent design patterns across different users. Another technical advantage of the disclosed techniques is that the design options generated previously for such design prompts can be cached and reused, thereby obviating the need to regenerate design geometry when similar design contexts are encountered. These technical advantages provide one or more technological advancements over prior art approaches.

1. Some embodiments include a computer-implemented method for generating designs, the method comprising determining a design context based on a first user input, retrieving a set of design prompts based on the design context, determining a first design prompt included in the set of design prompts based on a second user input, retrieving a set of design options based on the first design prompt, determining a first design option included in the set of design options based on third user input, and incorporating the first design option into the design context.

2. The computer-implemented method of clause 1, wherein determining the design context based on the first user input comprises receiving a user selection of design geometry included in a design workspace.

3. The computer-implemented method of any of clauses 1-2, wherein determining the design context based on the first user input comprises determining a user selection of a region of a design workspace that includes design geometry.

4. The computer-implemented method of any of clauses 1-3, wherein retrieving the set of design prompts based on the design context comprises identifying at least one design context stored in a generative design database that is substantially similar to the design context, wherein the set of design prompts is associated with the at least one design context.

5. The computer-implemented method of any of clauses 1-4, wherein retrieving the set of design prompts based on the design context comprises generating a first geometric embedding based on the design context, identifying a second geometric embedding within a geometric embedding space that is substantially similar to the first geometric embedding, and determining an additional design context that is associated with the second geometric embedding, wherein the set of design prompts is associated with the additional design context.

6. The computer-implemented method of any of clauses 1-5, wherein incorporating the first design option into the design context comprises integrating design geometry associated with the first design option into a design workspace that includes the design context.

7. The computer-implemented method of any of clauses 1-6, further comprising retrieving an additional set of design options by receiving a user prompt, generating a first semantic embedding of the user prompt, and determining a set of semantic embeddings within a semantic embedding space that are substantially similar to the first semantic embedding, wherein the set of semantic embeddings corresponds to an additional set of design prompts, and the additional set of design prompts corresponds to the additional set of design options.

8. The computer-implemented method of any of clauses 1-7, wherein a trained machine learning model retrieves the set of design prompts based on the design context from a generative design database.

9. The computer-implemented method of any of clauses 1-8, wherein a trained machine learning model retrieves the set of design options based on the first design prompt from a generative design database.

10. The computer-implemented method of any of clauses 1-9, wherein a generative design database stores the set of design prompts and the set of design options in a first shared library that is accessible to one or more users.

11. Some embodiments include one or more non-transitory computer readable media storing instructions that, when executed by one or more processors, cause the one or more processors to generate designs by performing the steps of determining a design context based on a first user input, retrieving a set of design prompts based on the design context, determining a first design prompt included in the set of design prompts based on a second user input, retrieving a set of design options based on the first design prompt, determining a first design option included in the set of design options based on third user input, and incorporating the first design option into the design context.

12. The one or more non-transitory computer readable media of clause 11, wherein the step of determining the design context based on the first user input comprises receiving a user selection of design geometry included in a design workspace.

13. The one or more non-transitory computer readable media of any of clauses 11-12, wherein the step of determining the design context based on the first user input comprises determining a user selection of a region of a design workspace that includes design geometry.

14. The one or more non-transitory computer readable media of any of clauses 11-13, wherein the step of retrieving the set of design prompts based on the design context comprises identifying at least one design context stored in a generative design database that is substantially similar to the design context, wherein the set of design prompts is associated with the at least one design context.

15. The one or more non-transitory computer readable media of any of clauses 11-14, wherein the step of retrieving the set of design prompts based on the design context comprises generating a first geometric embedding based on the design context, identifying a second geometric embedding within a geometric embedding space that is substantially similar to the first geometric embedding, and determining an additional design context that is associated with the second geometric embedding, wherein the set of design prompts is associated with the additional design context.

16. The one or more non-transitory computer readable media of any of clauses 11-15, wherein the step of incorporating the first design option into the design context comprises integrating design geometry associated with the first design option into a design workspace that includes the design context.

17. The one or more non-transitory computer readable media of any of clauses 11-16, further comprising the step of retrieving an additional set of design options by receiving a user prompt, generating a first semantic embedding of the user prompt, and determining a set of semantic embeddings within a semantic embedding space that are substantially similar to the first semantic embedding, wherein the set of semantic embeddings corresponds to an additional set of design prompts, and the additional set of design prompts corresponds to the additional set of design options.

18. The one or more non-transitory computer readable media of any of clauses 11-17, further comprising the step of causing a trained machine learning model to generate the first design prompt based on the first design option, wherein the first design prompt comprises a text description of the first design option.

19. The one or more non-transitory computer readable media of any of clauses 11-18, further comprising the steps of modifying the first design prompt based on fourth user input to generate a second design prompt, updating the first design option based on the second design prompt to generate a second design option, and storing the second design prompt and the second design option in a generative design database, wherein the second design option is associated with the second design prompt, and the second design prompt is associated with the design context.

20. Some embodiments include a computer system, comprising one or more memories that include instructions, and one or more processors that are coupled to the one or more memories and, when executing the instructions, are configured to generate designs by determining a design context based on a first user input, retrieving a set of design prompts based on the design context, determining a first design prompt included in the set of design prompts based on a second user input, retrieving a set of design options based on the first design prompt, determining a first design option included in the set of design options based on third user input, and incorporating the first design option into the design context.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a "module," a "system," or a "computer." In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating designs, the method comprising:determining a design context based on a first user input;retrieving a set of design prompts based on the design context;determining a first design prompt included in the set of design prompts based on a second user input;retrieving a set of design options based on the first design prompt;determining a first design option included in the set of design options based on third user input; and incorporating the first design option into the design context.

2. The computer-implemented method of claim 1, wherein determining the design context based on the first user input comprises receiving a user selection of design geometry included in a design workspace.

3. The computer-implemented method of claim 1, wherein determining the design context based on the first user input comprises determining a user selection of a region of a design workspace that includes design geometry.

4. The computer-implemented method of claim 1, wherein retrieving the set of design prompts based on the design context comprises identifying at least one design context stored in a generative design database that is substantially similar to the design context, wherein the set of design prompts is associated with the at least one design context.

5. The computer-implemented method of claim 1, wherein retrieving the set of design prompts based on the design context comprises:generating a first geometric embedding based on the design context;identifying a second geometric embedding within a geometric embedding space that is substantially similar to the first geometric embedding; anddetermining an additional design context that is associated with the second geometric embedding, wherein the set of design prompts is associated with the additional design context.

6. The computer-implemented method of claim 1, wherein incorporating the first design option into the design context comprises integrating design geometry associated with the first design option into a design workspace that includes the design context.

7. The computer-implemented method of claim 1, further comprising retrieving an additional set of design options by:receiving a user prompt;generating a first semantic embedding of the user prompt; and determining a set of semantic embeddings within a semantic embedding space that are substantially similar to the first semantic embedding, wherein the set of semantic embeddings corresponds to an additional set of design prompts, and the additional set of design prompts corresponds to the additional set of design options.

8. The computer-implemented method of claim 1, wherein a trained machine learning model retrieves the set of design prompts based on the design context from a generative design database.

9. The computer-implemented method of claim 1, wherein a trained machine learning model retrieves the set of design options based on the first design prompt from a generative design database.

10. The computer-implemented method of claim 1, wherein a generative design database stores the set of design prompts and the set of design options in a first shared library that is accessible to one or more users.

11. One or more non-transitory computer readable media storing instructions that, when executed by one or more processors, cause the one or more processors to generate designs by performing the steps of:determining a design context based on a first user input;retrieving a set of design prompts based on the design context;determining a first design prompt included in the set of design prompts based on a second user input;retrieving a set of design options based on the first design prompt;determining a first design option included in the set of design options based on third user input; andincorporating the first design option into the design context.

12. The one or more non-transitory computer readable media of claim 11, wherein the step of determining the design context based on the first user input comprises receiving a user selection of design geometry included in a design workspace.

13. The one or more non-transitory computer readable media of claim 11, wherein the step of determining the design context based on the first user input comprises determining a user selection of a region of a design workspace that includes design geometry.

14. The one or more non-transitory computer readable media of claim 11, wherein the step of retrieving the set of design prompts based on the design context comprises identifying at least one design context stored in a generative design database that is substantially similar to the design context, wherein the set of design prompts is associated with the at least one design context.

15. The one or more non-transitory computer readable media of claim 11, wherein the step of retrieving the set of design prompts based on the design context comprises:generating a first geometric embedding based on the design context;identifying a second geometric embedding within a geometric embedding space that is substantially similar to the first geometric embedding; and determining an additional design context that is associated with the second geometric embedding, wherein the set of design prompts is associated with the additional design context.

16. The one or more non-transitory computer readable media of claim 11, wherein the step of incorporating the first design option into the design context comprises integrating design geometry associated with the first design option into a design workspace that includes the design context.

17. The one or more non-transitory computer readable media of claim 11, further comprising the step of retrieving an additional set of design options by:receiving a user prompt;generating a first semantic embedding of the user prompt; and determining a set of semantic embeddings within a semantic embedding space that are substantially similar to the first semantic embedding, wherein the set of semantic embeddings corresponds to an additional set of design prompts, and the additional set of design prompts corresponds to the additional set of design options.

18. The one or more non-transitory computer readable media of claim 11, further comprising the step of causing a trained machine learning model to generate the first design prompt based on the first design option, wherein the first design prompt comprises a text description of the first design option.

19. The one or more non-transitory computer readable media of claim 11, further comprising the steps of:modifying the first design prompt based on fourth user input to generate a second design prompt;
updating the first design option based on the second design prompt to generate a second design option; and
storing the second design prompt and the second design option in a generative design database, wherein the second design option is associated with the second design prompt, and the second design prompt is associated with the design context.

20. A computer system, comprising: one or more memories that include instructions; and one or more processors that are coupled to the one or more memories and, when executing the instructions, are configured to generate designs by: determining a design context based on a first user input, retrieving a set of design prompts based on the design context, determining a first design prompt included in the set of design prompts based on a second user input, retrieving a set of design options based on the first design prompt; determining a first design option included in the set of design options based on third user input, and incorporating the first design option into the design context.
